(19) United States
(12) Patent Application Publication
(10) Pub. No.: US 2005/0064095 A1
(43) Pub. Date: Mar. 24, 2005

(54) Method for applying wear and corrosion resistant coating to cast iron

(75) Inventor: Gopal Subray Revankar, Moline, IL (US)

Correspondence Address: Jimmie R. Oaks;Patent Department, DEERE & COMPANY, One John Deere Place, Moline, IL, 61265-8098, US

(73) Assignee: Deere & Company, a Delaware corporation

(21) Appl. No.: 10/666,648

(22) Filed: Sep. 19, 2003

(51) Int. Cl. B05D 3/02

(52) U.S. Cl. 427/189

(57) ABSTRACT

A method for applying a wear and corrosion resistant coating to a cast iron part, wherein the coating process includes a fusing step, includes an initial step of decarburizing the area of the cast iron part to be coated to an effective depth for preventing adsorption of carbon into the un-fused coating when the part, together with the un-fused coating, is heated for fusing the alloy contained in the un-fused coating.

### FIELD OF THE INVENTION

The present invention relates to placing wear resistant coatings on cast iron.

### BACKGROUND OF THE INVENTION

Many machinery components, especially those of agricultural, construction, mining, and forestry equipment tend to wear out by general wear processes and also by corrosion, and mostly, by the synergistic effect of both wear and corrosion. While there are several processes available for surface modification to reduce wear, using a slurry coating process has been preferred in many applications where appearance or fine dimensional tolerances are not a requirement. This is so because the coating applied in this manner has the favorable characteristics of: (a) being quickly applied; (b) being relatively inexpensive; (c) having good wear and corrosion resistance; (d) having good impact resistance; and (e) forming a very good metallurgical bond with steel substrates. U.S. Pat. No. 5,879,743 discloses such a slurry coating process.

While the aforementioned patent states that the same slurry coating may be applied to either a white or gray cast iron substrate, it has been found that a problem arises due to formation of a liquid metal at the interface between the iron substrate and the coating surface when the part is heated to the fusing or sintering temperature of about 1085-1100° C. Thus, the liquid metal at the interface is formed while the top layer of the same slurry coating is fused or sintered without forming a liquid. During the fusing process, the top layer retains the same composition as that of the starting powder and remains solid or semi-solid while the layer at the interface tends to flow out from the zone of the interface into uncoated areas of the substrate where it is least desired. This leads to a part which does not have an even-depth coating over the desired area, which is not desirable, and which results in the part being out of tolerance. The part must be scrapped if such tolerances are critical.

The problem to be solved then is how to overcome the above-noted problem when coating cast iron substrates using the slurry coating process.

### SUMMARY OF THE INVENTION

According to the present invention, there is provided an improved slurry-coating process for coating cast iron substrates.

An object of the invention is to provide a slurry-coating process for coating cast iron substrates which eliminates the problem of liquid metal flowing out from the interface between the substrate and the slurry coating during the step of fusing the slurry coating to the substrate.

The above-noted object is achieved by decarburizing the cast iron substrate to a pre-determined depth prior to the slurry coating and fusing process.

This and other objects of the invention will become apparent from a reading of the ensuing description together with the appended drawings.

### BRIEF DESCRIPTION OF THE DRAWINGS

FIG. 1 depicts, in a schematic fashion, a prior art cast iron substrate coated with a slurry including an alloy, which will form a wear and corrosion resistant layer on the substrate once the alloy is fused, prior to the fusing step.

FIG. 2 is a view like FIG. 1, but showing how the relatively high carbon content of the cast iron at the interface of the slurry coating and the substrate affects the interface during the step of fusing the alloy.

FIG. 3 is a view like FIG. 2, but showing the irregular final dimension of the cast iron substrate with the coating following the step of fusing the alloy.

FIG. 4 is a view like FIG. 2, but showing a cast iron substrate that has undergone a decarburization cycle prior to being coated with the slurry coating.

### DESCRIPTION OF THE PREFERRED EMBODIMENT

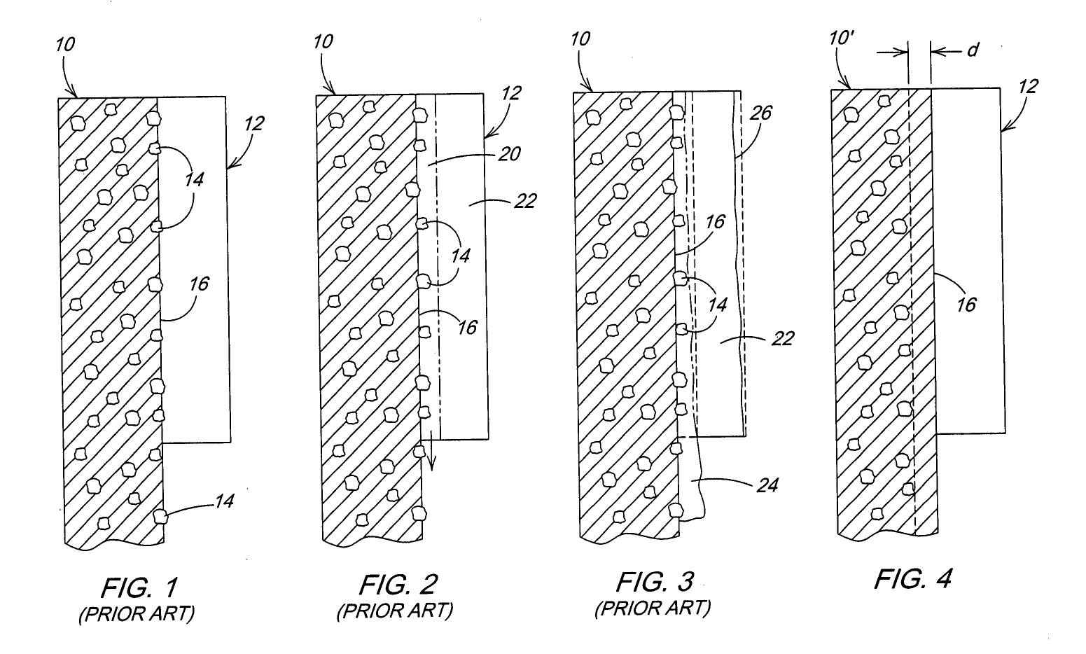

Referring now to FIGS. 1-3, there is shown a schematic of a cross section through a cast iron part 10 defining a substrate on which a slurry coating 12 has been applied. The coating 12 is preferably an acqueous solution of polyvinyl alcohol (PVA) used as the binder in an acqueous slurry of an alloy without a flux, as disclosed in U.S. Pat. No. 5,879,743, granted to Revankar on 9 Mar. 1999, the contents of which are incorporated herein by reference. The cast iron part 10 is here depicted as nodular iron containing free graphite or carbon in the form of nodules 14 which are dispersed throughout the part, with some of the nodules 14 being at an interface 16 between the part 10 and the slurry coating 12. It is here noted that the principles of the invention, stated below, would apply equally well if the part 10 were gray iron, with the graphite or carbon being in the form of flakes.

The nodular cast iron part 10 has a melting point between 1150-1260° C. The fusion or sintering temperature of the slurry coating 12 is between 1085-1100° C., which is below the melting point of the cast iron part, but still relatively high. It was discovered that, at this fusing temperature range, carbon nodules 14 at the interface 16 diffuse into a contacting or inner coating layer 20 of the slurry coating 12, and thus change the composition of the coating layer 20 to one of higher carbon percentage, which has a generally lower melting point than the alloy in the outer layer 22 of the slurry coating 12. Thus, when the fusing temperature is reached, the outer layer 22 of the coating 12 begins fusing into a solid or semi-solid material, while the inner layer 20 of the coating 12 becomes liquid and flows out from the interface, as depicted at 24 in FIG. 3, and forms puddles or globules. Assuming the desired dimension of the part 10 with the layer of slurry coating 12 is that shown in FIGS. 1 and 2, it can be seen that the run out of the liquid slurry coating, as depicted in FIG. 3, results in the outer boundary 26 of slurry coating 12 “shrinking” within the previous boundary, while the boundary of the part 10, that is below the slurry coating 12, as originally applied, “grows”. Accordingly, the desired dimension of the part is lost and, if the dimension is critical, the part must be scrapped.

It has been found that this undesirable result can be avoided or greatly minimized if the amount of free carbon at the casting surface is removed by a decarburization heat treatment cycle before coating and fusing. Referring to FIG. 4, there is shown a cast iron part 10′ that has been decarburized to a depth d prior to being coated with the slurry coating 12. Since little or no free carbon exists close to the interface 16, little or no carbon is absorbed by the slurry coating 12, and consequently, the composition, and hence, the melting point of an inner layer of the coating 12 adjacent to the interface 16 is unchanged from that of the remainder of the coating 12. This being the case, the entire coating 12 is fused without the melting and run-out of the coating occurring at the interface between the casting and the coating.

In an experiment which leads to this finding, a few ductile castings were subjected to a decarburization heat treatment cycle. The cycle involved heating the castings to 1800° F. for two hours, and then, air cooling the castings. The cycle produced a decarburized zone 0.5 mm deep. These decarburized castings and also a set of like castings which were not decarburized were given a slurry coating. The castings were then heated to the fusing temperature of the slurry coating. The result was that none of the decarburized castings showed that any liquid metal formation had occurred at the interface between the casting and the coating. In contrast, all of the castings that were not decarburized showed that liquid metal had formed at the interface between the casting and the coating and had flowed to areas not intended to be coated.

In further experiments, it has been found that the depth of decarburization for a casting to be coated with the slurry coating having the composition disclosed herein should be about 0.25 mm deep to be effective in preventing the formation of liquid metal during the fusing step. In any event, those skilled in the art can easily determine what the effective depth of decarburization is for any appropriate slurry coating composition by fusing the slurry coating on cast iron parts having different depths of decarburization and inspecting the parts to see if any melting occurred during fusing the slurry coating. Because coatings of similar compositions can be applied to a cast iron substrate by a thermal spray process, it is thought that decarburizing the area of the casting to be coated will likewise be beneficial for coatings applied in this manner.

The above suggests that the decarburization process may also help the adhesion of other types of coatings such as chrome plating. These coatings may or may not involve fusion of the coatings.

Having described the preferred embodiment, it will become apparent that various modifications can be made without departing from the scope of the invention as defined in the accompanying claims.

1. In a method of applying a coating including a finely powdered, wear resistant alloy to a surface area of a cast iron part in order to produce a coated area having increased wear, the method including the steps of:
(a) decarburizing at least said surface area of said cast iron part to an effective depth;
(b) coating said surface area of the cast iron part with said finely powdered, wear resistant alloy; and
(c) fusing said coating by heating said cast iron part together with said coating to a temperature below the melting point of said cast iron part but sufficient to cause said alloy of said coating to fuse.

2. The method of applying a coating, as defined in claim 1, wherein said coating is applied by a slurry coating process.

3. The method of applying a coating, as defined in claim 2, wherein said effective depth is about 0.25 mm.

4. The method of applying a coating, as defined in claim 2, wherein said effective depth is between about 0.25 mm and 0.5 mm.

5. The method of applying a coating, as defined in claim 1, wherein said coating is applied by a thermal spray process.

6. A method of applying a coating, including at least one of a wear resistant or corrosion resistant alloy, to a cast iron part comprising the steps of:
(a) decarburizing an area of said cast iron part which is desired to be coated with said coating; and
(b) applying said coating to said area of said cast iron part by a process resulting in said coating adhering to said cast iron part.
